(19) United States
(12) Patent Application Publication
(10) Pub. No.: US 2025/0381697 A1
(43) Pub. Date: Dec. 18, 2025

(54) METHOD FOR OPERATING A CONTINUOUS BLADE

(71) Applicant: PHILIP MORRIS PRODUCTS S.A., Neuchatel (CH)

(72) Inventors: Caroline Odermatt, Neuchatel (CH); Veronica Perenzin, Milano (IT); Annalaura Vitullo, Milano (IT); Matteo Defilippi, Neuchatel (CH)

(21) Appl. No.: 18/880,888

(22) PCT Filed: Jul. 3, 2023
(86) PCT No.: PCT/EP2023/068149

§ 371 Date: Jan. 3, 2025

(30) Foreign Application Priority Data
Jul. 5, 2022 (EP) 22183055.7

(51) Int. Cl. B26D 1/46; B26D 3/28; B26D 7/26

(52) U.S. Cl. CPC B26D 1/46; B26D 3/28; B26D 7/26

(57) ABSTRACT

The invention relates to a method for operating a continuous blade comprising—providing a continuous blade, -providing a movable support surface, the support surface conveying a material sheet, -arranging the continuous blade relative to the movable support surface so that a first part of the continuous blade contacts the movable support surface in a first region of the movable support surface and a second part of the continuous blade contacts the movable support surface in a second region of the movable support surface, -wherein the first part of the continuous blade removes the material sheet from the movable support surface, and -wherein the second part of the continuous blade removes residues of the material sheet from the movable support surface.

The present invention relates to a method for operating a continuous blade. The present invention further relates to an apparatus for the production of a material sheet.

Material sheets, such as a sheet of aerosol-forming substrate or a polymer thin film sheet are often deposited by a wet process involving slurry onto a movable support surface, such as a conveyor belt for drying. After drying and evaporation of the solvents a solid material sheet is formed which has to be removed from the movable support surface.

Removing the material sheet from the movable support surface and subsequently cleaning the support surface is often very laborious. The step of removal of the material sheet may employ a different device in comparison to cleaning the support surface. Servicing and operating these different devices may be laborious. Servicing and operating these devices may require frequent interruptions of the production process for the material sheet.

Removing and cleaning may involve employing a blade. Operating such a blade may pose safety issues. In particular, changing the blade may pose safety issues. Regularly changing the blade may produce a lot of waste. This may be due to the fact that sheets of the blade which fit into a blade holder have to be cut from a long coil of the blade. This may result in waste, such as offcut.

It would be desirable to provide a method for operating a blade which reduces the safety issues. It furthermore would be desirable to provide a method for operating a blade which would be less laborious. It would be desirable to provide a method for operating a blade which would require less interruptions of the production process for the material sheet. Furthermore, it would be desirable to provide an apparatus for the production of a material sheet which poses less safety issues and which requires less interruptions of the manufacturing process.

According to an embodiment of the present invention there is provided a method for operating a continuous blade. The method may comprise a method step of providing a continuous blade. The method may furthermore comprise providing a movable support surface. The support surface may convey a material sheet. The method may furthermore comprise arranging the continuous blade relative to the movable support surface so that a first part of the continuous blade contacts the movable support surface in a first region of the movable support surface. The continuous blade may be arranged relative to the movable support surface so that a second part of the continuous blade contacts the movable support surface in a second region of the movable support surface. The first part of the continuous blade may remove the material sheet from the movable support surface. The second part of the continuous blade may remove residues of the material sheet from the movable support surface.

According to another embodiment of the present invention there is provided a method for operating a continuous blade. The method comprises the method step of providing a continuous blade. Furthermore, the method comprises the method step of providing a movable support surface, the support surface conveying a material sheet. The continuous blade is arranged relative to the movable support surface so that the first part of the continuous blade contacts the movable support surface in a first region of the movable support surface. The continuous blade is also arranged relative to the movable support surface so that a second part of the continuous blade contacts the movable support surface in a second region of the movable support surface. The first part of the continuous blade removes the material sheet from the movable support surface. The second part of the continuous blade removes residues of the material sheet from the movable support surface.

The method of the invention may allow the removal of the material sheet from the movable support surface and the removal of residues of the material sheet which remain on the movable support surface after removal of the material sheet in an easy way. The method may also allow the simultaneous removal of the material sheet and any residues of the material sheet remaining on the movable support surface after removal of the material sheet. The method may also allow to use one single continuous blade for both the removal of the material sheet and the removal of residues of the material sheet from the movable support surface. This may provide an easier method which reduces the waste and offcut of the blade compared to a method where separate blades are used for removing the material sheet and for removing residues of the material sheet from the movable support surface. The method of the invention may also reduce the need to replace used blades when they have become blunt. This may greatly reduce the need to interrupt the wet process of depositing the slurry onto the movable support surface for replacing the blades. This may also provide a method which is cheaper compared to a method wherein separate blades are used for removing the material sheet and for removing residues of the material sheet.

After the residues of the material sheet have been removed from the movable support surface, the support surface may be re-used in order to deposit another sheet material on its surface.

The term “first part of the continuous blade” and “second part of the continuous blade” refer to a first portion and a second portion of a single continuous blade.

The continuous blade may comprise a one-piece member of blade. Preferably, the continuous blade is formed as a monolithic continuous band of a blade. The continuous blade may be in the form of a coil. The coil of the continuous blade may be configured to be unwound in order to be arranged relative to the movable support surface.

This may provide an easy method of providing a continuous blade which can be unwound from a coil.

The movable support surface may comprise a transporting direction for conveying the material sheet. The continuous blade may be guided over the first region of the movable support surface diagonally to the transporting direction. The continuous blade may be guided over the second region of the movable support surface diagonally to the transporting direction.

This may provide an easy method for arranging and guiding the continuous blade over one or both of the first region of the movable support surface and the second region of the movable support surface. This may allow the first part of the continuous blade to continuously remove the material sheet from the movable support surface conveying the material sheet. This may also allow the second part of the continuous blade to continuously remove the residues of the material sheet from the movable support surface while the movable support surface conveys the material sheet.

The first part of the continuous blade may be guided over the first region of the movable support surface perpendicularly to the transport direction. The second part of the continuous blade may be further guided over the second region of the movable support surface perpendicularly to the transport direction.

This may allow for a particularly easy removal of either the material sheet or the residues of the material sheet from the movable support surface. This may allow an efficient removal of either the material sheet or the residues of the material sheet. This may allow safe removal of either the material sheet or the residues of the material sheet.

The first part of the continuous blade may be arranged upstream of the second part of the continuous blade with respect to the transport direction of the material sheet via the movable support surface.

This may allow the first part of the continuous blade to remove the material sheet. This may also allow the second part of the continuous blade to remove any residues from the support surface remaining on the movable support surface after removal of the material sheet.

The first part of the continuous blade may be guided over the first region of the movable support surface in a first guiding direction. The second part of the continuous blade may be guided over the second region of the movable support surface in a second guiding direction. The second guiding direction may be reverse to the first guiding direction.

This may allow guiding different parts of the continuous blade in different first and second guiding directions over the movable support surface. This may provide a space-saving method for employing the different first and second parts of the continuous blade. This may provide an easy method to guide and arrange the first part of the continuous blade relative to the second part of the continuous blade.

The continuous blade may comprise a first intermediate part between the first part and the second part. A guiding direction of the continuous blade in the first intermediate part may be changed from the first guiding direction to the second guiding direction.

The continuous blade may be continuously guided over the first region and the second region of the movable support surface while the material sheet is continuously conveyed via the movable support surface.

This may provide an easy method for continuously guiding the continuous blade over the first region and the second region of the movable support surface. This may allow large parts of the continuous blade to be continuously used for both the removal of the material sheet and the removal of residues of the material sheet from the movable support surface. This method may use a large part or preferably all of the continuous blade. This may provide a continuous wear of the continuous blade over the complete area of the continuous blade. This may reduce a frequency of replacing the used blade after it became blunt.

In particular, the first part of the continuous blade may be guided over the first region of the movable support surface in the first guiding direction. After being guided over the first region of the movable support surface this part of the continuous blade may become the first intermediate part of the continuous blade. In this first intermediate part, the guiding direction of the continuous blade may be reversed from the first guiding direction to the second guiding direction. Subsequently, the part of the continuous blade whose guiding direction was changed in the first intermediate part may be guided as the second part of the continuous blade in the second guiding direction over the second part of the movable support surface. This may provide an easy method for continuously guiding the continuous blade over the movable support surface while the transport surface conveys the material sheet. This may provide an easy method for employing the complete continuous blade for removal of the material sheet and for removal of the residues of the material sheet.

The continuous blade may be guided over the first region of the movable support surface and over the second region of the movable support surface with a constant speed.

This may enable a particular easy way of continuously conveying the material sheet and removing the material sheet from the transport surface.

The movable support surface may comprise a drum for moving the transport surface. The movable support surface may be a continuous belt which is continuously moved between two opposing drums. An upper part of the movable support surface may be transported in a forward transporting direction and a lower part of the transport surface may be transported in a backward transporting direction. This may allow a continuous operation of a continuous belt as a movable support surface.

The drum may be configured for changing the transport direction of the movable support surface. The drum may be configured for changing the transport direction from the forward transporting direction to the backward transporting direction.

The continuous blade may be arranged relative to the movable support surface so that the first part of the continuous blade contacts the movable support surface in the first region of the movable support surface where a change of the transporting direction takes place.

This may allow the first part of the continuous blade to remove the material sheet from the movable support surface with greater ease. In particular, the material sheet, once disconnected from the movable support surface may easily transported to a secondary movable support surface. The material sheet may be further dried on the secondary movable support surface and further processed. The material sheet may be rolled into a bobbin after drying on the secondary support surface. The material sheet for example may fall off the movable support surface on a second transport surface where the material sheet is further dried and processed.

A temperature of the material sheet, in particular a sheet of aerosol-forming substrate may be at a temperature of 80 to 90 degrees Celsius, preferably at a temperature of 83 to 87 degrees Celsius when the first part of the continuous blade removes the material sheet from the movable support surface. At this temperature of the material sheet may be easily removed from the movable support surface.

The movable support surface may comprise a heat conductive material. The movable support surface may comprise a flexible metal belt. The movable support surface may comprise an endless conveyor belt, preferably an endless stainless steel conveyor belt. This may allow an even distribution of the heat after the deposition of the slurry on the steel conveyor belt. This may allow a uniform drying of the slurry on the movable support surface thereby forming the material sheet. This may also allow an easy removal of the material sheet from the stainless steel conveyor belt.

One or both of the first part of the continuous blade and the second part of the continuous blade may be arranged relative to the movable support surface so that one or both of the first part of the continuous blade and the second part of the continuous blade contact the movable support surface in an area of contact between the drum and the movable support surface.

This may ease removal of the material sheet from the movable support surface. This may allow an easy separation of the material sheet from the movable support surface.

A feed roll may be employed for providing a bobbin of the continuous blade. The feed roll may be configured for unwinding the first part of the continuous blade and the second part of the continuous blade.

This may provide an easy way of providing a longer coil of the continuous blade.

The feed roll may be employed for rolling up the first part of the continuous blade and the second part of the continuous blade after both parts have contacted the movable support surface.

This may provide a method for continuously unwinding and rolling up the continuous blade while guiding the continuous blade over the movable support surface.

The continuous blade may be formed as a continuous band, for example a continuous metal band with a first sharp edge on one end of the metal band. The band of the continuous blade may be located in a plane. The continuous blade may be arranged relative to the movable support surface so that a contact angle between the plane in which the first part of the continuous band is located and the plane along which the movable surface extends is between 19 to 25 degrees, preferably between 21 to 23 degrees. This may enhance the efficiency of the removal of the material sheet from the movable support surface.

A roll may be employed in the first intermediate part of the continuous blade for changing from the first guiding direction to the second guiding direction.

A roll may allow to change the guiding direction of the continuous blade from the first guiding direction to the second guiding direction while continuously guiding the continuous blade over the movable support surface.

In a further embodiment of the method of the present invention one or both of a first blade holder in the first region of the movable support surface and second blade holder in the second region of the movable support surface may be present. The first blade holder may be configured for guiding the first part of the continuous blade in the first region of the movable support surface. The second blade holder may be configured for guiding the second part of the continuous blade in the second region of the movable support surface.

The first blade holder may be configured to arrange the first part of the continuous blade relative to the first region of the movable support surface, so that the first part of the continuous blade can contact the first region of the movable support surface. This may allow a reliable removal of the material sheet from the movable support surface in the first region.

The second blade holder may be configured to arrange the second part of the continuous blade relative to the second region of the movable support surface, so that the second part of the continuous blade can contact the second region of the movable support surface. This may allow a reliable removal of residues of the material sheet from the second region of transport surface.

One or both of the first and second blade holder may be formed as guide rails. The guide rails may be configured for holding the first part of the continuous blade and the second part of the continuous blade, respectively in place.

A wire, in particular a sharp metal wire may be used as the continuous blade. Preferably, a continuous band may be used as a continuous blade. The continuous band may be a continuous metal band. The continuous blade may be a metal band with at least one first sharp edge. The at least one first sharp edge may be employed for contacting the first region and the second region of the movable support surface in order to remove the material sheet and the residues of the material sheet. The metal band may for example be one of stainless steel or alloyed carbon steel.

The continuous band of the continuous blade may have a length. The length may be between 5 meters and 500 meters, preferably up to 450 meters.

The method of the present invention may allow using the complete length of the band of the continuous blade. In particular, the complete length of the band of the continuous blade may be guided over the first region of the movable support surface and over the second region of the movable support surface. This method may be repeated until the complete length of the band of the continuous blade has become blunt. For example, the continuous band of the continuous blade may be in the form of a coil, such as a bobbin. The continuous band of the blade may be unwound and guided over the first region and the second region of the movable support surface and may subsequently be wound up as a coil again. Subsequently, the continuous band of the blade may be unwound again and guided over the movable support surface repeatedly until the continuous band of the blade has become blunt and needs to be replaced.

This may avoid any of waste of the continuous blade, for example offcut, which may result if the continuous blade has to be cut into individual stripes in order to be mounted in conventional doctor blade holders.

The continuous band may comprise a first sharp edge and an opposing second sharp edge. The first sharp edge may be employed for contacting the movable support surface in the first region of the movable support surface. The first sharp edge may also be employed for contacting the movable support surface in the second region of the movable support surface.

After the first sharp edge of the continuous band of the blade has become blunt, the continuous band may be rotated, so that the second sharp edge contacts the movable support surface. Subsequently the second sharp edge may be employed for removal of the material sheet and the residues of the material sheet in the first and second region of the movable support surface.

According to another embodiment of the method of the invention the continuous blade comprising the first sharp edge and the opposing second sharp edge may be rotated between the first region of the movable support surface and the second region of the movable support surface. This may lead to the second sharp edge being employed for contacting the second region of the movable support surface. In this embodiment of the method of the invention the first sharp edge may contact the first region of the movable support surface.

Such a method may allow employing both, the first sharp edge and the second sharp edge of the continuous blade, reducing the necessity to stop the manufacturing process of the material sheet and replace the continuous blade. Such a method may allow the same level of efficiency when employing the first sharp edge and the second sharp edge of the continuous blade. This may reduce the risk of lower efficiency when removing the residue of the material sheet from the second region of the movable support surface.

The continuous blade may comprise a bobbin of one of our wire or a band with a sharp edge. Preferably the continuous blade is a metal band with at least one first sharp edge. The continuous blade may be a metal band with second sharp edge opposing the first sharp edge, as already described above.

The material sheet may comprise one of an aerosol-forming substrate, preferably homogenized aerosol-forming substrate, a thin film from food industry, for example dough or a polymer thin film.

Preferably the material sheet is a homogenized tobacco or plant material sheet which includes aerosol-forming substrate.

In a further embodiment the invention provides a method as described herein, wherein a continuous blade is employed. The continuous blade may comprise a first end, a second end and an intermediate section located between the first end and the second end. The intermediate section may comprise at least one sharp edge. The first end and the second end may be free of sharp edges. The first end may comprise a first connection element configured for being connectable to a second connection element. The second end may comprise a second connection element configured for being connectable to the first connection element.

Such a continuous blade may allow an operator to handle the blade by one or both of the first end and the second end which are free of sharp edges. This may increase the safety of handling the continuous blade. This may reduce the risk of the operator being hurt by the at least one sharp edge in the intermediate section. This may allow an operator to easily connect the continuous blade to replacement continuous blade once the continuous blade is in need to be replaced.

The continuous blade may be guided over the first region of the movable support surface and over the second region of the movable support surface multiple times until the continuous blade may be in need to be replaced. The need to be replaced may happen if the continuous blade has become too blunt in order to reliably remove the material sheet from the movable support surface. The first connection element of the continuous blade in need to be replaced may be connected to a second connection element of replacement continuous blade. The continuous blade in need to be replaced may be continued to be guided over the first region of the movable support surface and over the second region of the movable support surface, the replacement continuous blade thereby replacing the continuous blade need to be replaced.

This may provide an easy method of replacing the continuous blade in need to be replaced by a replacement continuous blade. This may allow an operator to simply replace the continuous blade without the need to handle the blade in the intermediate section comprising the sharp edge. By connecting the replacement continuous blade to the blade in need to be replaced and further guiding the blade in need to be replaced through the moving device of the continuous blade may provide an easy method to thread the replacement continuous blade into the apparatus. After the replacement continuous blade is completely threaded into the apparatus for the production of the material sheet, in particular the moving device, the continuous blade in need to be replaced can be disconnected from the replacement continuous blade. The continuous blade in need to be replaced can subsequently be discarded. The method of the invention can be continued with the fresh replacement continuous blade.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetra-decanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material. The final slurry may contain low amounts of tobacco. In particular the final slurry may contain up to 5 weight percent based on the total weight of the aerosol-forming substrate. Preferably, the final slurry contains a tobacco extract. This may produce an aerosol-forming substrate containing a tobacco extract.

Additionally, the aerosol-forming substrate may contain flavorants. These flavorants may impart a flavor, such as menthol, apple, mint, grapefruit, or vanilla.

The slurry or dough for obtaining the material sheet may comprise all components mentioned above and may also include solvents such as water most of which will be evaporated when the solid material sheet is formed on the movable support surface.

The invention furthermore provides an apparatus for the production of a material sheet. The apparatus may comprise a movable support surface configured for conveying the material sheet in a transport direction. The apparatus may also comprise a moving device with a continuous blade. The moving device may be configured for moving the continuous blade over a first region of the movable support surface. The moving device may be configured for moving the continuous blade over a second region of the movable support surface. A first part of the continuous blade in the first region of the movable support surface may be arranged upstream of the second part of the continuous blade in the second region of the movable support surface with respect to the transport direction of the material sheet. The moving device may be configured to bring the first part of the continuous blade in contact with the first region of the movable support surface. The moving device may be configured to bring the second part of the continuous blade in contact with the second region of the movable support surface.

According to another embodiment of the invention an apparatus for the production of a material sheet is provided. The apparatus comprises a movable support surface configured for conveying a material sheet in a transport direction. The apparatus furthermore comprises a moving device with a continuous blade, wherein the moving device is configured for moving the continuous blade over a first region of the movable support surface. The moving device is also configured for moving the continuous blade over a second region of the movable support surface. A first part of the continuous blade in the first region of the movable support surface is arranged upstream of the second part of the continuous blade in the second region of the movable support surface with respect to the transport direction. The moving device is configured to bring the first part of the continuous blade in contact with the first region of the movable support surface. The moving device is also configured to bring the second part of the continuous blade in contact with the second region of the movable support surface.

The moving device may be configured to bring the first part of the continuous blade in contact with the first region of the movable support surface so that the material sheet located on the movable support surface can be removed from the support surface. The moving device of the apparatus may also be configured to bring the second part of the continuous blade in contact with the second region of the movable support surface so that any residue of the material sheet located on the movable support surface after removal of the material sheet may be removed by the second part of the continuous blade.

Such an apparatus may be configured to remove the material sheet from the movable support surface with the first part of the continuous blade and clean the movable support surface from any remaining residue of the material sheet with the second part of the continuous blade so that the movable support surface can be re-used. The movable support surface may be cleaned, for example with water and dried before being re-used.

The moving device may be configured to guide the first part of the continuous blade over the first region of the movable support surface in a first direction. The moving device may be configured to guide the second part of the continuous blade over the second region of the movable support surface in a second direction. The second direction may be reverse to the first direction.

This may allow a space-saving arrangement of the continuous blade in the first and second region of the movable support surface.

The moving device may be configured to guide the continuous blade over the first region of the movable support surface diagonally to the transport direction of the material sheet. Preferably the moving device may be configured to guide the continuous blade over the first region of the movable support surface perpendicularly to the transport direction of the material sheet.

The moving device may be further configured to guide the continuous blade over the second region of the movable support surface diagonally to the transport direction of the material sheet. Preferably, the moving device may be configured to guide the continuous blade over the second region of the movable support surface perpendicularly to the transport direction of the material sheet.

The moving device may further comprise a feed roll. The feed roll may be configured for providing a bobbin of the continuous blade. The feed roll may particularly be configured for unwinding the first part of the continuous blade and the second part of the continuous blade.

The feed roll may also be configured for receiving the continuous blade after being guided over the first and second region of the movable support surface.

The moving device may furthermore comprise a roll. The roll may be configured for changing the first guiding direction of the continuous blade to the second guiding direction of the continuous blade.

The moving device may comprise the roll for changing the guiding direction and the feed roll. The moving device may be configured to guide the continuous blade continuously between the feed roll and the roll in the first guiding direction and in the second guiding direction.

This may lead to the complete length of the continuous blade being used for the removal of the material sheet and the residues of the material sheet.

The moving device of the apparatus may be configured for moving the continuous band of blade comprising a first sharp edge and an opposing second sharp edge. The moving device may furthermore be configured to rotate the continuous band about a longitudinal axis of the band between the first region of the movable support surface and the second region of the movable support surface. This may lead to the moving device being configured to bring the first sharp edge in contact with the first region of the movable support surface. This may lead to the moving device being configured to bring the second sharp edge in contact with the second region of the movable support surface.

The invention furthermore provides a continuous blade. The continuous blade comprises a first end. The continuous blade comprises a second end. The continuous blade comprises an intermediate section comprising at least one sharp edge. The intermediate section is located between the first end and the second end. The intermediate section comprises at least one sharp edge. The first end and the second end are free of sharp edges. The first end comprises a first connection element configured for being connectable to a second connection element. The second end of the continuous blade comprises a second connection element configured for being connectable to the first connection element.

The invention furthermore provides a continuous blade. The continuous blade may comprise a first end. The continuous blade may comprise a second end. The continuous blade may comprise an intermediate section comprising at least one sharp edge. The intermediate section may be located between the first end and the second end. The intermediate section may comprise at least one sharp edge. The first end and the second end may be free of sharp edges. The first end may comprise a first connection element configured for being connectable to a second connection element. The second end of the continuous blade may comprise a second connection element configured for being connectable to the first connection element.

Such a continuous blade may easily be handled by an operator via one or both of the first end and the second end without the risk of hurting the operator. The first end and the second end of the continuous blade may ease the handling of the blade without the need to handle the blade in the intermediate section comprising the at least one sharp edge. The first connection element of the first end of a first continuous blade may easily be connected to a second connection element of a second continuous blade. This may allow the second continuous blade to replace the first continuous blade when the first continuous blade is in need to be replaced. The second continuous blade may have the same design as the first continuous blade, including a first and second end flanking an intermediate section with at least one sharp edge. In particular, the first continuous blade may be continued to be guided through the apparatus for the production of the material sheet, in particular the moving device when it is connected to the second continuous blade. This may allow the second continuous blade to be threaded into the moving device of the apparatus for the production of the material sheet. This may enable an easy replacement of the first continuous blade by the second continuous blade without the need to handle the blades in the intermediate section comprising the at least one sharp edge. After the second continuous blade has been completely threaded into the moving device of the apparatus, the first continuous blade can be disconnected from the second continuous blade and can be discarded.

The invention also provides a continuous blade being free of any sharp edges. This continuous blade may comprise a central section. The central section may comprise a first end and a second end. At least one of the first end and the second end may comprise a first connection element being configured to be connectable to a second connection element.

Such a continuous blade being free of any sharp edges may serve as a “dummy” blade which may be used when starting the apparatus for the production of the material sheet. This “dummy” blade can easily be handled by an operator and can be positioned in the moving device of the apparatus without the risk of hurting the operator. A continuous blade including an intermediate section comprising at least one sharp edge may be connected to the “dummy” blade by connecting the first connection element of the “dummy” blade to a second connection element of the continuous blade with the sharp edge. When the “dummy” blade is guided through the moving device, it will automatically also thread the continuous blade with sharp edge into the moving device.

Below, there is provided a non-exhaustive list of non-limiting examples. Any one or more of the features of these examples may be combined with any one or more features of another example, embodiment, or aspect described herein.

Example E1: Method for operating a continuous blade comprising:
providing a continuous blade,
providing a movable support surface, the support surface conveying a material sheet,
arranging the continuous blade relative to the movable support surface so that a first part of the continuous blade contacts the movable support surface in a first region of the movable support surface and a second part of the continuous blade contacts the movable support surface in a second region of the movable support surface,
wherein the first part of the continuous blade removes the material sheet from the movable support surface, and
wherein the second part of the continuous blade removes residues of the material sheet from the movable support surface.

Example E2: Method according to example E1, wherein the movable support surface comprises a transport direction for conveying the material sheet and wherein the continuous blade is guided over the first region of the movable support surface diagonally to the transport direction, preferably wherein the continuous blade is further guided over the second region of the movable support surface diagonally to the transport direction.

Example E3: Method according to the preceding example, wherein the continuous blade is guided over the first region of the movable support surface perpendicularly to the transport direction, preferably wherein the continuous blade is further guided over the second region of the movable support surface perpendicularly to the transport direction.

Example E4: Method according to any of the preceding examples, wherein the movable support surface comprises a transport direction for conveying the material sheet and wherein the first part of the continuous blade is arranged upstream of the second part of the continuous blade with respect to the transport direction.

Example E5: Method according to any of the preceding examples, wherein the first part of the continuous blade is guided over the first region of the movable support surface in a first guiding direction, and wherein the second part of the continuous blade is guided over the second region of the movable support surface in a second guiding direction, wherein the second guiding direction is reverse to the first guiding direction.

Example E6: Method according to the preceding example, wherein the continuous blade comprises a first intermediate part between the first part and the second part and wherein a guiding direction of the continuous blade in the first intermediate part is changed from the first guiding direction to the second guiding direction.

Example E7: Method according to any of the preceding examples, wherein the continuous blade is continuously guided over the first region and the second region of the movable support surface, while the material sheet is continuously conveyed via the movable support surface.

Example E8: Method according to any of the preceding examples, wherein the movable support surface comprises a drum for moving the transport surface, preferably wherein the drum is for changing the transporting direction of the movable support surface.

Example E9: Method according to the preceding example, wherein one or both the first part of the continuous blade and the second part of the continuous blade are arranged relative to the movable support surface so that one or both the first part of the continuous blade and the second part of the continuous blade contact the movable support surface in an area of contact between the drum and the movable support surface.

Example E10: Method according to any of the preceding examples, wherein a feed roll is employed for providing a bobbin of the continuous blade, preferably wherein the feed roll is for unwinding the first part of the continuous blade and the second part of the continuous blade.

Example E11: Method according to the preceding example, wherein the feed roll is for rolling up the first part of the continuous blade and the second part of the continuous blade after having contacted the movable support surface.

Example E12: Method according to any of the preceding examples further being dependent on example E6, wherein a roll is employed in the first intermediate part for changing from the first guiding direction to the second guiding direction.

Example E13: Method according to any of the preceding examples, wherein one or both of a first blade holder in the first region of the movable support surface and a second blade holder in the second region of the movable support surface are present, wherein the first blade holder is configured for guiding the first part of the continuous blade in the first region of the movable support surface and wherein the second blade holder is configured for guiding the second part of the continuous blade in the second region of the movable support surface.

Example E14: Method according to any of the preceding examples, wherein one of: a wire or a continuous band is used as the continuous blade, preferably wherein the continuous band is used as the continuous blade.

Example E15: Method according to the preceding example, wherein the continuous band comprises a first sharp edge and an opposing second sharp edge, wherein the first sharp edge is employed for contacting the movable support surface in the first region of the movable support surface.

Example E16: Method according to the preceding example, wherein the first sharp edge is employed for contacting the movable support surface in the second region of the movable support surface.

Example E17: Method according to the preceding example E15, wherein the continuous blade is rotated between the first region of the movable support surface and the second region of the movable support surface so that the second sharp edge is employed for contacting the second region of the movable support surface.

Example E18: Method according to any of the preceding examples, wherein the continuous blade comprises a bobbin of one of a wire or a band with a sharp edge, preferably wherein the continuous blade is a metal band with at least one sharp edge.

Example E19: Method according to any of the preceding examples, wherein the movable support surface comprises an endless conveyor belt.

Example E20: Method according to any of the preceding examples, wherein the material sheet comprises one of:
aerosol-forming substrate, preferably homogenized aerosol-forming substrate, films for food industry, or
a polymer thin film.

Example E21. Method according to any of the preceding examples, wherein a continuous blade is employed, the continuous blade comprising a first end, a second end and an intermediate section located between the first end and the second end, wherein the intermediate section comprises at least one sharp edge, wherein the first end and second end are free of sharp edges, the first end comprising a first connection element configured for being connectable to a second connection element and the second end comprising a second connection element configured for being connectable to the first connection element.

Example E22. Method according to the preceding example, wherein the continuous blade is guided over the first region of the movable support surface and over the second region of the movable support surface multiple times until the continuous blade is in need to be replaced,
wherein the first connection element of the continuous blade in need to be replaced is connected to a second connection element of a replacement continuous blade and wherein the continuous blade in need to be replaced is continued to be guided over the first region of the movable support surface and over the second region of the movable support surface, the replacement continuous blade thereby replacing the continuous blade in need to be replaced.

Example E23: Apparatus for the production of a material sheet, comprising:
a movable support surface configured for conveying a material sheet in a transport direction,
a moving device with a continuous blade, wherein the moving device is configured for moving the continuous blade over a first region of the movable support surface and wherein the moving device is configured for moving the continuous blade over a second region of the movable support surface,
wherein a first part of the continuous blade in the first region of the movable support surface is arranged upstream of a second part of the continuous blade the second region of the movable support surface with respect to the transport direction, and
wherein the moving device is configured to bring the first part of the continuous blade in contact with the first region of the movable support surface, and
wherein the moving device is configured to bring the second part of the continuous blade in contact with the second region of the movable support surface.

Example E24: Apparatus according to the preceding example, wherein the moving device is configured to bring the first part of the continuous blade in contact with the first region of the movable support surface so that the first part is able to remove the material sheet from the movable support surface, and wherein the moving device is configured to bring the second part of the continuous blade in contact with the second region of the movable support surface so that the second part is able to remove residues of the material sheet from the movable support surface.

Example E25: Apparatus according to any of the preceding examples E23 or E24, wherein the moving device is configured to guide the first part of the continuous blade over the first region of the movable support surface in a first guiding direction, and wherein the moving device is configured to guide the second part of the continuous blade over the second region of the movable support surface in a second guiding direction, wherein the second guiding direction is reverse to the first guiding direction.

Example E26: Apparatus according to any of the preceding examples E23 to E25, wherein the moving device is configured to guide the continuous blade over the first region of the movable support surface diagonally to the transport direction, preferably wherein the moving device is further configured to guide the continuous blade over the second region of the movable support surface diagonally to the transport direction.

Example E27: Apparatus according to any of the preceding examples E23 to E26, wherein the moving device further comprises a feed roll, wherein the feed roll is configured for providing a bobbin of the continuous blade, preferably wherein the feed roll is configured for unwinding the first part of the continuous blade and the second part of the continuous blade.

Example E28: Apparatus according to any of the preceding examples E23 to E27, further dependent on example E23, wherein the moving device further comprises a roll wherein the roll is configured for changing from the first guiding direction to the second guiding direction.

Example E29: Apparatus according to any of the preceding examples E23 to E28, wherein the moving device is configured for moving a continuous band of a blade comprising a first sharp edge and an opposing second sharp edge, wherein the moving device is further configured to rotate the continuous band about a longitudinal axis of the band between the first region of the movable support surface and the second region of the movable support surface, preferably wherein the moving device is configured for bringing the first sharp edge in contact with the first region of the movable support surface and for bringing the second sharp edge in contact with the second region of the movable support surface.

Example E30. Continuous blade, comprising a first end, a second end and an intermediate section located between the first end and the second end, wherein the intermediate section comprises at least one sharp edge, wherein the first end and second end are free of sharp edges, the first end comprising a first connection element configured for being connectable to a second connection element and the second end comprising a second connection element configured for being connectable to the first connection element.

Features described in relation to one embodiment may equally be applied to other embodiments of the invention.

The invention will be further described, by way of example only, with reference to the accompanying drawings in which:

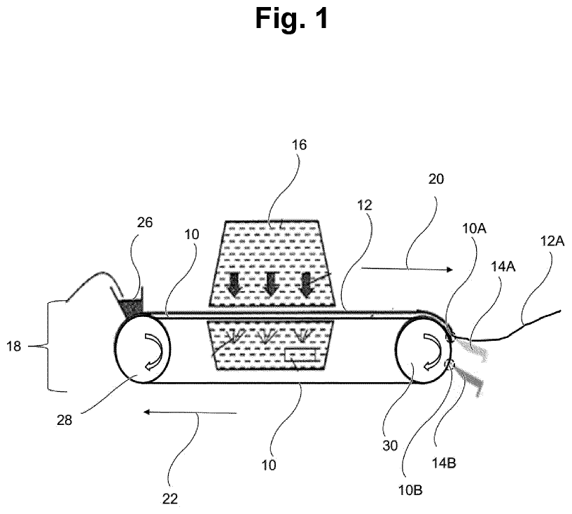

FIG. 1 shows a schematic cross-sectional view of an apparatus for production of a material sheet including the movable support surface and the continuous blade;

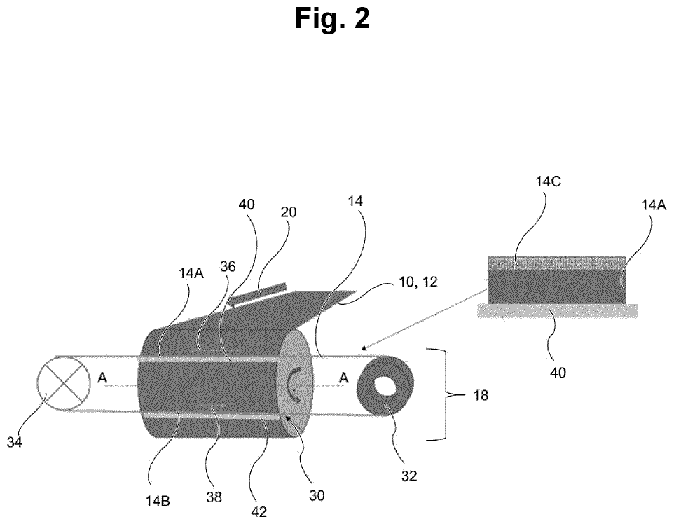

FIG. 2 shows a schematic perspective view of the apparatus for producing the material sheet including the roles and blade holders;

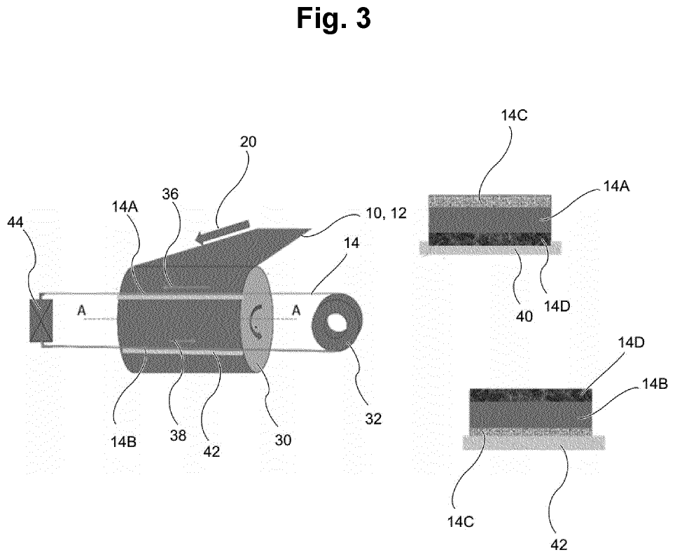

FIG. 3 shows a schematic perspective view of another embodiment of the apparatus;

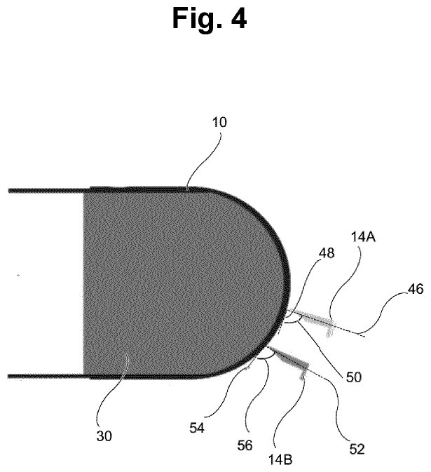

FIG. 4 shows a schematic cross-sectional view of the first part and the second part of the continuous blade contacting the movable support surface with the respective contact angles.

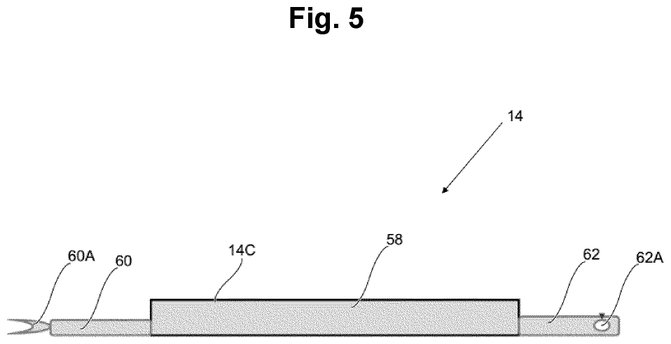

FIG. 5 shows a schematic drawing of one embodiment of the continuous blade with connection elements; and

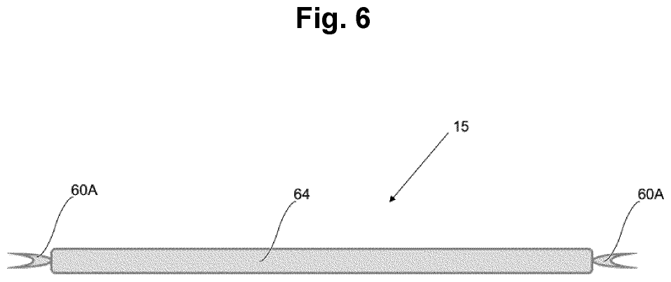

FIG. 6 depicts a schematic drawing of blunt “dummy” blade for mounting the continuous blade in an apparatus for producing the material sheet.

In the following elements have the same functionality are marked with the same reference numerals throughout all the figures.

FIG. 1 depicts a schematic cross-sectional view of an apparatus 18 for producing a material sheet. The apparatus includes a movable support surface 10 and two separate drums 28 and 30 for moving the support surface 10. Both drums 28 and 30 perform rotations as indicated by the respective arrows within the drums so that an upper part of the movable support surface 10 is moved in a forward transporting direction as indicated by the arrow 20 and a lower part of the movable support surface 10 is moved in a backward transporting direction as indicated by the arrow 22. Preferably, the movable support surface is an endless conveyor belt. A casting box 26 including slurry of the material for the sheet is employed in order to homogeneously distribute the slurry including the material of the material sheet onto the movable support surface 10. Preferably, the slurry of the material for the sheet comprises homogenized tobacco or plant material for producing a sheet of homogenized tobacco or plant material. The slurry distributed on the movable support surface 10 is dried by a heating device 16, thereby producing the material sheet 12. In an area of the drum 30 where the forward transporting direction 20 changes into the backward transporting direction 22 the continuous blade is located. For the sake of clarity only the first part 14A of the continuous blade and the second part 14B of the continuous blade are shown in FIG. 1. The first part 14A of the continuous blade contacts the movable support surface in a first region 10A of the support surface, whereas the second part 14B of the continuous blade contacts the movable support surface in a second region 10B of the support surface. The first part 14A of the continuous blade is located upstream of the second part 14B of the continuous blade with respect to the transporting direction of the movable support surface. The first part 14A of the continuous blade removes the material sheet 12 from the movable support surface 10 resulting in a detached material sheet 12A. The detached material sheet 12A may be further processed for example on a further conveyor belt and might be dried to further reduce the humidity content of the material. The second part 14B of the continuous blade is located further downstream with respect to the transporting direction of the movable support surface and is able to remove residues of the material sheet which are still attached to the movable support surface from the support surface. After this cleaning step, the movable support surface can return to the casting box so that another layer of material can be deposited on the movable support surface.

FIG. 2 depicts a schematic front view of the apparatus 18 for producing the material sheet. This FIG. 2 only shows a part of the movable support surface, namely the drum 30 which rotates about the axis denoted with “A” and which transports the material sheet 12 located on the movable support surface 10 in the forward transporting direction 20. The apparatus 18 includes a feed roll 32 which comprises a bobbin of a continuous band of the blade which can be unwound in the first guiding direction 36 and which can be guided over movable support surface perpendicular to the forward transporting direction 20 of the material sheet. The first blade holder 40, for example a guide rail is present which guides the continuous blade 14 over movable support surface. In particular, the first blade holder 40 is configured for guiding the first part 14A of the continuous blade over the first region of the movable support surface for removing the material sheet. After having passed the movable transport surface through the first blade holder 40, the continuous blade 14 is received by the roll 34 which is configured to change the guiding direction of the continuous blade. After having changed the guiding direction, the second part 14B of the continuous blade is guided by the second blade holder 42 in the second guiding direction 38 over the second region of the movable support surface. This second part 14B of the continuous blade is able to remove residue of the material sheet still attached to the movable support surface from the support surface. Subsequently, the continuous blade 14 leaves the second region of the movable support surface in order to be received by the feed roll 32. This method of guiding the continuous blade 14 through the first blade holder 40 onto the roll 34 and further into the second blade holder 42 and back to the feed roll can be repeated multiple times until the continuous blade 14 has become blunt. The right-hand side of FIG. 2 shows an enlarged partial view of the first part 14A of the continuous blade received in the first blade holder 40. One side of the continuous blade includes a first sharp edge 14C. This sharp edge is employed in order to remove the material sheet from the movable support surface in the first part of the continuous blade and in order to remove the residues of the material sheet in the second part of the continuous blade.

FIG. 3 depicts a different embodiment of the apparatus 18 for providing a material sheet in comparison to FIG. 2. This apparatus 18 is configured to be operated with a continuous band of a blade having a first sharp edge 14C and an opposing second sharp edge 14D. This apparatus 18 includes the same elements as the apparatus shown in FIG. 3, except that the roll 34 has been replaced by a device 44 for rotating the continuous blade. When the continuous blade 14 is unwound from the feed roll 32 the first sharp edge 14C of the continuous blade 14 is employed for removing the material sheet from the movable support surface 10. Subsequently, the device 44 rotates the continuous blade about its longitudinal axis so that the second sharp edge 14D can be brought into contact with the movable support surface. This second sharp edge 14D is then employed in order to remove any residue of the material sheet from the movable support surface. The enlarged view of the continuous blade 14 in the upper right-hand part of the figure shows the first part 14A of the continuous blade wherein the continuous blade is guided by the first blade holder 40 by contacting the second sharp edge 14D of the blade. The first part 14A of the continuous blade therefore contacts the movable support surface via its first sharp edge 14C. The enlarged view of the continuous blade in the lower right-hand part of the figure shows the second part 14B of the continuous blade after having passed the device 44 for rotating the continuous blade. In this case, the first sharp edge 14C of the continuous blade is guided through the second blade holder 42 and the second sharp edge 14D is in contact with the movable support surface for removing the residue of the material sheet. This embodiment of the apparatus 18 is able to employ two opposing first and second sharp edges 14C and 14D of the continuous band of the blade without the need to manually rotate the blade. This greatly reduces the need to replace the continuous blade which therefore has a higher service life. The device 44 for rotating the continuous blade may comprise a twisted guide rail which is formed in such a way in order to rotate the continuous blade about its longitudinal axis so that the second sharp edge 14D can come in contact with the movable support surface. The device 44 rotating the continuous blade may comprise a housing. The housing may ensure that the blade is not accessible by an operator while being rotated.

FIG. 4 shows an enhanced schematic partial view of the region of the movable support surface 10 which is in contact with the drum 30. The first part 14A of the continuous blade and the second part 14B of the continuous blade are visible. The first part 14A of the continuous blade extends along a plane 46, whereas the movable support surface in this first region extends along a plane 48. A contact angle 50 which is located between both planes 46 and 48 can be determined which is between 19 and 25 degrees, preferably between 21 and 23 degrees as described herein. Similarly, the second part 14B of the continuous blade extends along a plane 52 and the respective part of the movable support surface in this second region of the support surface extends along a plane 54. A contact angle 56 extending between both planes 52 and 54 can be determined similar to the contact angle 50. These contact angles 50 and 56 respectively ensure the best mode of operation for the first part and the second part of the continuous blade. These contact angles also may reduce the risk of breakage of the movable support surface. These contact angles also may reduce the risk that any residue remains on the movable support surface.

FIG. 5 shows a schematic drawing of one embodiment of the continuous blade 14 including a first end 60 and a second end 62. The first end comprises a first connection element 60A, for example a clip. The second end 62 comprises a second connection element 62A, for example an area to attach the clip of the first connection element. The first end and the second end flank an intermediate section 58, which includes a first sharp edge 14 C. Such a continuous blade 14 can easily be handled by one or both of its first end and second end without the risk of hurting the operator.

FIG. 6 shows a schematic drawing of a blunt “dummy” blade which includes a central section 64 which is free of any sharp edges. Both ends of the central section 64 include first connection elements 60A, for example clips. These first connection elements can be connected to a second connection element of a continuous blade including an intermediate section with a sharp edge in order to position this continuous blade in the moving device of the apparatus for producing the material sheet. The “dummy” blade reduces the risk of the operator getting hurt when handling the blades. The central section can easily be handled by an operator without the risk of getting hurt.

1. A method for operating a continuous blade comprising:
providing a continuous blade,
providing a movable support surface, the support surface conveying a material sheet,
arranging the continuous blade relative to the movable support surface so that a first part of the continuous blade contacts the movable support surface in a first region of the movable support surface and a second part of the continuous blade contacts the movable support surface in a second region of the movable support surface,
wherein the first part of the continuous blade removes the material sheet from the movable support surface, and
wherein the second part of the continuous blade removes residues of the material sheet from the movable support surface.

2. The method according to claim 1, wherein the movable support surface comprises a transport direction for conveying the material sheet and wherein the continuous blade is guided over the first region of the movable support surface diagonally to the transport direction.

3. The method according to claim 2, wherein the continuous blade is guided over the first region of the movable support surface perpendicularly to the transport direction.

4. The method according to claim 1, wherein the movable support surface comprises a transport direction for conveying the material sheet and wherein the first part of the continuous blade is arranged upstream of the second part of the continuous blade with respect to the transport direction.

5. The method according to claim 1, wherein the first part of the continuous blade is guided over the first region of the movable support surface in a first guiding direction, and wherein the second part of the continuous blade is guided over the second region of the movable support surface in a second guiding direction, wherein the second guiding direction is reverse to the first guiding direction.

6. The method according to claim 1, wherein the continuous blade is continuously guided over the first region and the second region of the movable support surface, while the material sheet is continuously conveyed via the movable support surface.

7. The method according to claim 5, wherein a roll is employed for changing from the first guiding direction to the second guiding direction.

8. The method according to claim 1, wherein one or both of a first blade holder in the first region of the movable support surface and a second blade holder in the second region of the movable support surface are present, wherein the first blade holder is configured for guiding the first part of the continuous blade in the first region of the movable support surface and wherein the second blade holder is configured for guiding the second part of the continuous blade in the second region of the movable support surface.

9. The method according to claim 1, wherein one of a wire or a continuous band is used as the continuous blade.

10. The method according to claim 9, wherein the continuous band comprises a first sharp edge and an opposing second sharp edge, wherein the first sharp edge is employed for contacting the movable support surface in the first region of the movable support surface.

11. The method according to claim 10, wherein the continuous blade is rotated between the first region of the movable support surface and the second region of the movable support surface so that the second sharp edge is employed for contacting the second region of the movable support surface.

12. An apparatus for production of a material sheet, comprising:
a movable support surface configured for conveying a material sheet in a transport direction,
a moving device with a continuous blade, wherein the moving device is configured for moving the continuous blade over a first region of the movable support surface and wherein the moving device is configured for moving the continuous blade over a second region of the movable support surface,
wherein a first part of the continuous blade in the first region of the movable support surface is arranged upstream of a second part of the continuous blade the second region of the movable support surface with respect to the transport direction, and
wherein the moving device is configured to bring the first part of the continuous blade in contact with the first region of the movable support surface, and
wherein the moving device is configured to bring the second part of the continuous blade in contact with the second region of the movable support surface.

13. The apparatus according to claim 12, wherein the moving device further comprises a roll wherein the roll is configured for changing from a first guiding direction to a second guiding direction.

14. The apparatus according to claim 12, wherein the moving device is configured for moving a continuous band of a blade comprising a first sharp edge and an opposing second sharp edge, wherein the moving device is further configured to rotate the continuous band about a longitudinal axis of the band between the first region of the movable support surface and the second region of the movable support surface.

15. A continuous blade, comprising a first end, a second end and an intermediate section located between the first end and the second end, wherein the intermediate section comprises at least one sharp edge, wherein the first end and second end are free of sharp edges, the first end comprising a first connection element configured for being connectable to a second connection element and the second end comprising a second connection element configured for being connectable to the first connection element.

16. The method according to claim 1, wherein the movable support surface comprises a transport direction for conveying the material sheet and wherein the continuous blade is guided over the first region of the movable support surface diagonally to the transport direction, and the continuous blade is further guided over the second region of the movable support surface diagonally to the transport direction.

17. The method according to claim 2, wherein the continuous blade is guided over the first region of the movable support surface perpendicularly to the transport direction, and the continuous blade is further guided over the second region of the movable support surface perpendicularly to the transport direction.

18. The method according to claim 1, wherein one of a wire or a continuous band is used as the continuous blade, and the continuous band is used as the continuous blade.

19. The apparatus according to claim 12, wherein the moving device is configured for moving a continuous band of a blade comprising a first sharp edge and an opposing second sharp edge, wherein the moving device is further configured to rotate the continuous band about a longitudinal axis of the band between the first region of the movable support surface and the second region of the movable support surface, and the moving device is configured for bringing the first sharp edge in contact with the first region of the movable support surface and for bringing the second sharp edge in contact with the second region of the movable support surface.
